(19) United States
(12) Patent Application Publication
(10) Pub. No.: US 2026/0283171 A1
(43) Pub. Date: Sep. 24, 2026

(54) MICROWAVE BURN PREVENTION AGENT, METHOD FOR PREVENTING MICROWAVE BURN OF FOOD, PRODUCTION METHOD FOR FROZEN FOOD, AND PRODUCTION METHOD FOR STARCH-CONTAINING FOOD TO BE HEATED BY MICROWAVE OVEN

(71) Applicant: The Nisshin OilliO Group, Ltd., Tokyo (JP)

(72) Inventors: Taichi WATANABE, Yokohama-shi, Kanagawa (JP); Takahiro OKADA, Yokohama-shi, Kanagawa (JP)

(73) Assignee: The Nisshin OilliO Group, Ltd., Tokyo (JP)

(21) Appl. No.: 18/873,702

(22) PCT Filed: Jun. 2, 2023
(86) PCT No.: PCT/JP2023/020645

§ 371 Date: Dec. 10, 2024

(30) Foreign Application Priority Data
Jun. 13, 2022 (JP) 2022-095004
Aug. 29, 2022 (JP) 2022-135544
Aug. 29, 2022 (JP) 2022-135545
Oct. 21, 2022 (JP) 2022-168971
Oct. 21, 2022 (JP) 2022-169044

(51) Int. Cl. A23B 2/85; A23D 7/00; A23L 29/00; A23L 29/206; A23L 35/00

(52) U.S. Cl. CPC A23B 2/85; A23D 7/001; A23L 29/04; A23L 29/206; A23L 35/10

(57) ABSTRACT

A microwave burn prevention agent for preventing microwave burn of food caused by microwave heating is provided.

### TECHNICAL FIELD

The present invention relates to a microwave burn prevention agent, a method for preventing microwave burn of food, a production method for frozen food, and a production method for starch-containing food to be heated in a microwave oven.

### BACKGROUND OF THE INVENTION

In order to reduce cooking work in restaurants and homes, prepared foods are increasingly distributed and stored frozen, chilled, or refrigerated, and heated in microwave ovens before serving. In particular, from the perspective of food loss, frozen foods with high shelf life are on the rise.

When these frozen, chilled, and refrigerated foods are heated in a microwave oven, “microwave burn (microwave browning)” occurs. The “microwave burn” is the drying, burning, or uneven heating of foods due to partial overheating. Since the appearance and texture of the food are impaired by “microwave burn,” compositions containing water, oil and/or fat, polyhydric alcohol, and emulsifiers have been proposed to prevent microwave burn (Patent Literature 1). Emulsions can be cost-effective by using more water, but in the method of Patent Literature 1, if the water content exceeds 83 mass % of the total composition, the resistance to freezing burn is considered insufficient and could not be used in areas with high water content. In addition, microwave burn prevention agent (i.e., inhibitor) in an emulsified state with a high water content had the problem of being prone to spoilage.

### CITATION LIST

### Patent Literature

Patent Literature 1: JP2016-2024A

### SUMMARY OF THE INVENTION

### Problem to be Solved

An object of the present invention is to provide a microwave burn prevention agent that prevents microwave burn of food. A further object of the present invention is to provide a method for preventing microwave burn of food. A still further object of the present invention is to provide a production method for frozen food in which microwave burn is prevented. A still another object of the present invention is to provide a production method for starch-containing food to be heated in a microwave oven in which microwave burn is prevented.

### Means for Solving the Problem

After careful studies, the inventors found that using a specific composition as a microwave burn prevention agent suppresses microwave burn and solves the above problems, thus achieving the present invention.

In other words, the present invention provides the following aspects [1] to [11].
[1] A microwave burn prevention agent for preventing microwave burn of food caused by microwave heating,
the microwave burn prevention agent including an oil-based component containing an oil and/or a fat and an emulsifier, and a polysaccharide thickener, wherein the microwave burn prevention agent is used as an emulsion having a viscosity of 100 to 13500 mPa·s (25° C.) or as an emulsion with a viscosity of 100 to 13500 mPa·s (25° C.) with added water.
[2] The microwave burn prevention agent, according to [1], wherein the oil-based component contains 20 to 80 mass % of the oil and/or the fat and 10 to 80 mass % of the emulsifier, wherein the emulsifier has an HLB of 3 to 10.
[3] The microwave burn prevention agent, according to [1], wherein the oil and/or the fat contains 30 mass % or more of linear saturated fatty acids having carbon numbers of 8 to 10 in fatty acids constituting the oil and/or the fat,
wherein the emulsifier is one or more selected from glycerol mono fatty acid esters, polyglycerol fatty acid esters, polyglycerol condensed-ricinoleate esters, organic acid monoglycerides, sorbitan fatty acid esters, sucrose fatty acid esters, polysorbates, propylene glycol fatty acid esters, and lecithin,
wherein the polysaccharide thickener is one or more selected from xanthan gum and galactomannan.
[4] The microwave burn prevention agent, according to [1], wherein a mass ratio of the oil-based component and the polysaccharide thickener in the microwave burn prevention agent is 300:1 to 3:1, and/or
the polysaccharide thickener in the emulsion is 0.01 to 2.5 mass %, and/or, 60 mass % or more of fatty acids constituting the emulsifier are unsaturated fatty acids in the emulsifier in the oil-based component.
[5] The microwave burn prevention agent, according to [1], wherein the food is a frozen food.
[6] A method for preventing microwave burn of food by microwave heating, including: applying an emulsion having a viscosity of 100 to 13500 mPa·s (25° C.) to a surface of the food before heating in a microwave oven,
wherein the emulsion is the microwave burn prevention agent of any one of [1] to [5] or an emulsion comprising the microwave burn prevention agent with added water,
wherein a total amount of the oil and/or the fat, the emulsifier, and the polysaccharide thickener in the emulsion is 0.08 to 3 mass parts per 100 mass parts of the food.
[7] A production method for frozen food to be heated in a microwave oven and eaten, including:
a step of applying an emulsion having a viscosity of 100 to 13500 mPa·s (25° C.) to a surface of the food before heating in a microwave oven; and
a step of successively freezing the food,
wherein the emulsion is the microwave burn prevention agent of any one of [1] to [5] or an emulsion comprising the microwave burn prevention agent with added water,
wherein a total amount of the oil and/or the fat, the emulsifier, and the polysaccharide thickener in the emulsion is 0.08 to 3 mass parts per 100 mass parts of the food.
[8] A microwave burn prevention agent for preventing microwave burn of starch-containing food caused by microwave heating,
wherein the microwave burn prevention agent is applied to a starch-containing food between a heating and cooking step and a freezing or refrigeration step of the starch-containing food,
wherein the microwave burn prevention agent contains 70 to 99.9 mass % of an oil and/or a fat and 0.1 to 30 mass % of an emulsifier,
wherein the emulsifier is one or more selected from propylene glycol fatty acid esters, polyglycerol fatty acid esters having HLB of 2 to 8, polyglycerol condensed-ricinoleate esters, organic acid monoglycerides, sucrose fatty acid esters having HLB of 1 to 3, and sorbitan fatty acid esters having HLB of 2 to 8.
[9] The microwave burn prevention agent, according to [8], wherein the emulsifier is one or more selected from propylene glycol fatty acid esters and polyglycerol fatty acid esters having HLB of 2 to 8.
[10] A production method for starch-containing food to be heated in a microwave oven, including:
after a step of heating and cooking the starch-containing hood, conducting a step of applying 0.5 to 10 mass parts to 100 mass parts of the microwave burn prevention agent of [8] a starch-containing food after the cooking process of the starch-containing food, followed by a step of freezing or refrigerating the starch-containing food.
[11] The production method for starch-containing food to be heated in a microwave oven, according to [10],
wherein the emulsifier contained in the microwave burn prevention agent is one or more selected from propylene glycol fatty acid esters and polyglycerol fatty acid esters having HLB of 2 to 8.

### Advantageous Effects of the Invention

According to the present invention, the occurrence of microwave burn of food due to microwave heating can be prevented. In particular, the occurrence of microwave burn can be more effectively suppressed for food with a large amount of heating by microwave heating, such as frozen food.

### MODE FOR CARRYING OUT THE INVENTION

Next, the present invention will be illustratively described in more detail. In the embodiment of the present invention, A (numerical value) to B (numerical value) means A or more and B or less. In addition, the preferred and more preferred modes, etc. exemplified below may be used in combination with each other as appropriate, regardless of expressions such as “preferred” and “more preferred”. In addition, the numerical value ranges are examples, and a range combining the upper and lower limits of each range and the numerical values in the examples may also be used as appropriate. Furthermore, terms such as “containing” or “including” may be read as “consisting essentially of” or “consisting of”.

### First Embodiment

### [Microwave Burn Prevention Agent 1]

A microwave burn prevention agent 1 in the present embodiment is a microwave burn prevention agent for preventing microwave burn of food caused by microwave heating, wherein the microwave burn prevention agent 1 contains an oil-based component containing an oil and/or fat and an emulsifier, and a polysaccharide thickener, and wherein the microwave burn prevention agent 1 is used as an emulsion having a viscosity of 100 to 13500 mPa·s (25° C.), or as an emulsion having a viscosity of 100 to 13500 mPa·s (25° C.) with added water.

### <Emulsion>

The microwave burn prevention agent 1 in the present embodiment is used either as the microwave burn prevention agent 1 itself being in a state of emulsion, or as an emulsion after being emulsified. When used after being emulsified, the microwave burn prevention agent 1 is mixed with water to form an emulsion. The emulsions are not limited to any particular type but include oil-in-water (O/W) emulsions, water-in-oil (W/O) emulsions, or W/O/W emulsions, and the oil-in-water emulsions are the preferred type.

The viscosity of the emulsion of the microwave burn prevention agent 1 in the present embodiment is higher than that of the emulsion without the polysaccharide thickener due to the presence of the polysaccharide thickener. The higher viscosity of the emulsion prevents microwave burns of food. However, if the viscosity is too high, the workability and coating of the food are inferior. Therefore, the microwave burn prevention agent 1 in the present embodiment is an emulsion having a viscosity of 100 to 13500 mPa·s (25° C.). According to the microwave burn prevention agent 1 in the present embodiment, an emulsion obtained by adding water to the microwave burn prevention agent 1 has a viscosity of 100 to 13500 mPa·s (25° C.). The microwave burn prevention agent 1 before adding water may be substantially water-free (no water phase) or emulsified with water. Water addition results in emulsification and/or dilution with water. Therefore, the substantially water-free microwave burn prevention agent 1 becomes an emulsion with the addition of water. The addition of water dilutes the emulsion 1, and the viscosity of the emulsion decreases. The microwave burn prevention agent 1 is preferably an emulsion with a viscosity of 100 to 10000 mPa·s (25° C.), or an emulsion with a viscosity of 100 to 10000 mPa·s (25° C.) when water is added to the microwave burn prevention agent 1. The microwave burn prevention agent 1 is more preferably an emulsion with a viscosity of 100 to 9000 mPa·s (25° C.), or an emulsion with a viscosity of 100 to 9000 mPa·s (25° C.) when water is added to the microwave burn prevention agent 1. The microwave burn prevention agent 1 is further preferably an emulsion with a viscosity of 400 to 5000 mPa·s (25° C.), or an emulsion with a viscosity of 400 to 5000 mPa·s (25° C.) when water is added to the microwave burn prevention agent 1. The microwave burn prevention agent 1 is most preferably an emulsion with a viscosity of 1000 to 2000 mPa·s (25° C.), or an emulsion with a viscosity of 1000 to 2000 mPa·s (25° C.) when water is added to the microwave burn prevention agent 1.

In the present invention, viscosity can be measured in accordance with the Standard Oil Analysis and Testing Method (2.2.10.5-2013 Viscosity (Brookfield method)) established by the Japan Oil Chemistry Society. For example, a BM-type viscometer can be used to measure viscosity one minute after the start of rotation.

<Oil and/or Fat>

The microwave burn prevention agent 1 in the present embodiment contains an oil-based component, and the oil-based component contains oil and/or fat. As oil and/or fat, animal and vegetable oil and/or fat, oil and/or fat synthesized from glycerin and fatty acids, and their fractionated oils, esterified oils, hydrogenated oils, etc., can be used alone or in combination.

Examples of animal and vegetable oil and/or fat include soybean oil, rapeseed oil, sunflower oil, olive oil, safflower oil, corn oil, cottonseed oil, rice oil, sesame oil, perilla oil, flaxseed oil, peanut oil, grapeseed oil, beef tallow, milk fat, fish oil, coconut oil, palm oil, and palm kernel oil.

Oil and/or fat synthesized from glycerin and fatty acids include oil and/or fat containing linear saturated fatty acids having carbon numbers of 8 to 10, such as triglycerides of medium-chain fatty acids (MCT: Medium Chain Triglycerides).

Fractionated oils include palm olein, palm super olein, palm stearin, palm mid-fraction, and other palm oil fractions.

As esterified oils, esterified oils of palm oil or fractionated palm oil and other liquid oil and/or fat, or esterified oils of MCT and vegetable oils, etc. can be used. Hydrogenated oils include hydrogenated oils from animal and vegetable oils and fractionated oils from animal and vegetable oils, as well as hydrogenated oils from esterified oils.

As to oil and/or fat used in the present invention, oil and/or fat that loses fluidity at room temperature need to be dissolved by heating when applied to food surfaces, so oil and/or fat that have fluidity at 30° C. are preferred. Even if some of the raw material oil and/or fat are solid at 30° C., they can be suitably used if they are used in combination with other raw material oil and/or fat, and if the oil and/or fat as a whole have fluidity. In particular, oil and/or fat containing linear saturated fatty acids having carbon numbers of 8 to 10 in the constituent fatty acids of oil and/or fat, rapeseed oil, palm olein, and mixtures thereof can be suitably used, as they have the advantage of being liquid oils with a low melting point and good oxidation stability. In particular, oil and/or fat in which 30 mass % or more of the constituent fatty acids of the fat or oil are linear saturated fatty acids having carbon numbers of 8 to 10 have good microwave burn prevention effects and are preferred. Oil and/or fat in which 50 to 100 mass % of the fatty acids constituting the fat or oil are linear saturated fatty acids having carbon numbers of 8 to 10 are more preferred, and oil and/or fat in which 80 to 100 mass % of the fatty acids constituting the fat or oil are linear saturated fatty acids having carbon numbers of 8 to 10 are further preferred. Linear saturated fatty acids having carbon numbers of 8 to 10 include caprylic acid and capric acid.

The microwave burn prevention agent 1 in the present embodiment preferably contains 20 to 80 mass % of oil and/or fat in the oil-based component. The microwave burn prevention agent 1 in the present embodiment is used as an emulsion or with added water, and when 20 to 80 mass % of oil and/or fat is contained in the oil-based component, the amount of emulsifier described below is sufficient to emulsify the oil and/or fat. In addition, by including the same range of oil and/or fat, together with the emulsifier and polysaccharide thickener described below, the microwave burn prevention property will be within an acceptable range. The amount of oil and/or fat in the oil-based component is preferably 30 to 70 mass %, more preferably 40 to 60 mass %, and especially preferably 45 to 55 mass %.

### <Emulsifier>

The microwave burn prevention agent 1 in the present embodiment contains an emulsifier in the oil-based component. Glycerol mono fatty acid esters, polyglycerol fatty acid esters, polyglycerol condensed-ricinoleate esters, organic acid monoglycerides, sorbitan fatty acid esters, sucrose fatty acid esters, polysorbates, propylene glycol fatty acid esters, lecithin, etc. can be used as emulsifiers.

The emulsifier in the present embodiment preferably has HLB of 3 to 10 in order to improve the microwave burn resistance of food. Emulsifiers having HLB of 3 to 10 also have an emulsifying function, and the same emulsifiers can be used to make emulsions in the present embodiment. For particularly efficient emulsification, HLB of the emulsifier is preferably 6 to 10, and more preferably 6 to 8.

HLB is an abbreviation of Hydrophile Lipophile Balance and is an indicator of whether an emulsifier is hydrophilic or lipophilic, with values ranging from 0 to 20. In the present invention, the Atlas method is used to calculate an HLB value. The calculation method of the Atlas method for calculating the HLB value is as follows,

$$HLB = 20 \times ( 1 - S / A )$$

S: Saponification value
A: Neutralization value of fatty acids in the ester

In this calculation method, the HLB value is calculated as an arithmetic mean.

In the present embodiment, the microwave burn prevention agent 1 preferably contains 10 to 80 mass % of emulsifier in the oil-based component. In this range, the emulsifier can be sufficiently emulsified together with the aforementioned oil and/or fat. It is more preferable for the emulsifier to be contained in the oil-based component at 10 to 60 mass %, 20 to 55 mass % is even more preferable, 30 to 50 mass % is especially preferable, and 35 to 45 mass % in the oil-based component is most preferable.

In order to prevent solidification at low temperatures, the emulsifier contained in the oil-based component preferably has 60 mass % or more of its constituent fatty acids as unsaturated fatty acids. It is more preferred that 70 to 100 mass % of the constituent fatty acids are unsaturated fatty acids, and it is even more preferred that 80 to 98 mass % of the constituent fatty acids are unsaturated fatty acids. The unsaturated fatty acids can be linear unsaturated fatty acids having carbon numbers of 16 to 22. One or two or more unsaturated fatty acids selected from oleic acid, linoleic acid, linolenic acid, and erucic acid are preferred. Particularly preferred is oleic acid, which is 65 to 90 mass % of the constituent fatty acids. Fatty acids other than unsaturated fatty acids in the emulsifier are saturated fatty acids. Linear saturated fatty acids having carbon numbers of 6 to 22 are preferred as saturated fatty acids, linear saturated fatty acids having carbon numbers of 16 to 22 are more preferred, and one or more of palmitic acid, stearic acid and behenic acid are further preferred.

The emulsifiers to be used are preferably diglycerol mono fatty acid esters and/or triglycerol mono fatty acid esters. These emulsifiers have a high function of emulsifying oil and/or fat as well as preventing microwave burn of foods. Therefore, it can be used alone or together with other emulsifiers. For example, diglycerol mono fatty acid esters can be used, which are produced by esterifying diglycerin and fatty acids. Diglycerol mono fatty acid esters and/or triglycerol mono fatty acid esters are preferably made by distillation of the reactants to increase the purity of the monoesters, but those containing diesters or triesters as impurities may also be used.

In the present embodiment, the microwave burn prevention agent 1 preferably contains 10 to 60 mass % of diglycerin mono fatty acid ester and/or triglycerin mono fatty acid ester in the oil-based component. If the blended amount is 10 mass % or more, emulsification can be sufficiently achieved. By keeping the blended amount 60 mass % or less, there is room for other emulsifiers to be blended, and synergistic effects with other emulsifiers can be expected. The content of diglycerol mono fatty acid esters and/or triglycerol mono fatty acid esters is more preferably 20 to 55 mass % in the oil-based component, even more preferably 30 to 50 mass % in the oil-based component, and especially preferably 35 to 45 mass % in the oil-based component.

In the present embodiment, it is preferable to use one or more emulsifiers selected from polyglycerol fatty acid esters with an average degree of polymerization of polyglycerol of 4 or more, organic acid monoglycerides, propylene glycol fatty acid esters, and lecithin for the microwave burn prevention agent 1. These emulsifiers can also be used alone, but using them simultaneously with the aforementioned diglycerol mono fatty acid esters and/or triglycerol mono fatty acid esters is effective in further improving the microwave burn prevention properties of foods. One or two or more emulsifiers selected from polyglycerol fatty acid esters with an average degree of polymerization of 4 or more, organic acid monoglycerides, propylene glycol fatty acid esters, and lecithin are preferably contained in the oil-based component at a rate of 0 to 40 mass %, more preferably at 5 to 30 mass %, even more preferably at 5 to 20 mass %, and especially preferably at 5 to 15 mass %.

Polyglycerol fatty acid esters with the average degree of polymerization of polyglycerol of 4 or more are synthesized by esterifying polyglycerol with fatty acids. Polyglycerol used as a raw material for polyglycerol fatty acid esters is generally obtained by dehydration-condensation of glycerin at high temperature in the presence of an alkali catalyst such as caustic soda, followed by distillation, deodorization, and decolorization as necessary. Polyglycerol, the raw material for these polyglycerol fatty acid esters, is also called reactive polyglycerol, and is a mixture of polyglycerol of different degrees of polymerization and has a wide degree of polymerization distribution. Polyglycerol fatty acid esters are generally allowed to be mixtures of polyglycerol fatty acid esters of various degrees of polymerization, since those with a degree of polymerization of 4 or more are difficult to isolate.

In the present invention, the average degree of polymerization indicates the degree of polymerization of polyglycerin constituting polyglycerol fatty acid esters. The average degree of polymerization here is a value calculated from the hydroxyl value of polyglycerol, the raw material of polyglycerol fatty acid esters. For example, the average degree of polymerization (n) can be derived from the following equations (Formula 1) and (Formula 2).

$$Molecular weight = 74 n + 18 \qquad ( Formula 1 )$$

$$Hydroxyl value = 56110 ( n + 2 ) / molecular weight \qquad ( Formula 2 )$$

Polyglycerin in general is then sold as tetraglycerin (average degree of polymerization 4), hexaglycerin (average degree of polymerization 6), decaglycerin (average degree of polymerization 10), etc., depending on the average degree of polymerization determined by the end group analysis method obtained by measuring hydroxyl group value. Therefore, the average degree of polymerization is a calculated value and may differ from the actual degree of polymerization.

In the present embodiment, the average degree of polymerization of the polyglycerol portion of polyglycerol fatty acid esters is preferably 4 to 12, more preferably 4 to 10, and especially preferably 6 to 8.

Organic acids constituting organic acid monoglycerides are not particularly limited, but citric acid, succinic acid, acetic acid, tartaric acid, butyric acid, etc. can be suitably used. Citric acid is particularly preferred because of its high microwave burn prevention effect.

Propylene glycol fatty acid esters are esters of propylene glycol and fatty acids, and those with HLB 3 to 10 can be suitably used.

Lecithin can be egg yolk lecithin or plant-derived lecithin, and plant-derived lecithin is preferred. The raw materials for plant-derived lecithin include crude oil obtained by pressing and/or extracting oilseeds such as soybeans, rapeseed, corn, sunflower, safflower, sesame, and linseed; oil tailings obtained by blowing water or steam into the crude oil to form sediment; crude lecithin obtained by drying the separated oil tailings; lecithin obtained by removing the neutral oil content from the crude lecithin by a known method such as solvent fractionation, etc., and furthermore, concentrated or highly purified lecithin in which specific phospholipids are concentrated and fractionated from the mixed lecithin can be used. In the present invention, lecithin made by deglycosylation of such raw materials is preferred because of its reduced coloration.

In the present invention, lecithin in emulsifiers can be defined as acetone insoluble matter as measured by the “Standard Oil Analysis and Testing Method 4.3.1-2013 Acetone Insoluble Matter” established by the Japan Oil Chemistry Society, but this measurement method is not suitable for measuring acetone insoluble matter of 5 mass % or less. Therefore, phosphorus content can be measured and converted into the lecithin content. For example, the phosphorus content of a starch-containing food loosening agent containing phosphorus may be determined by quantifying the phosphorus content using emission spectrometry (ICP emission spectrometer) using high-frequency inductively coupled plasma (ICP) as a light source, and since the atomic weight of phosphorus and molecular weight ratio of lecithin are generally 1:25, the phosphorus content may be multiplied by 25.

### <Polysaccharide Thickener>

The microwave burn prevention agent 1 in the present embodiment contains polysaccharide thickener. Polysaccharide thickener is a water-soluble high-molecular substance that exhibits viscosity or gels when dissolved in water, and which include, for example, xanthan gum, galactomannan, tamarind seed gum, carrageenan, agar, pectin, gum arabic, pullulan, and soy polysaccharides. One or two or more of these polysaccharides can be used. Preferably, one or more of xanthan gum and galactomannan are used. Guar gum and locust bean gum are also preferred as galactomannan.

In the present embodiment, the microwave burn prevention agent 1 is used as an emulsion or as an emulsion with added water, and the higher viscosity of the emulsion has the effect of preventing microwave burn of the food. For this reason, polysaccharide thickener is blended in the present embodiment. The mass ratio of the oil-based component and the polysaccharide thickener in the microwave burn prevention agent 1 is preferably 300:1 to 3:1, and/or the content of polysaccharide thickener in the emulsion is preferably 0.01 to 2.5 mass %. In this range, a certain increase in viscosity of the emulsion can be expected, and thus the effect of preventing microwave burn of the food is further enhanced. The mass ratio of the oil-based component to the polysaccharide thickener in the microwave burn prevention agent 1 is preferably 200:1 to 3:1, and more preferably 160:1 to 3:1. The content of polysaccharide thickener in the emulsion is more preferable at 0.05 to 2.0 mass %, and the content of polysaccharide thickener in the emulsion is even more preferable at 0.1 to 1.0 mass %.

### <Water>

The microwave burn prevention agent 1 is used as an emulsion or as an emulsion with a viscosity of 100 to 13500 mPa·s (25° C.) by adding water. Therefore, the microwave burn prevention agent 1 may contain water. The moisture content in the microwave burn prevention agent 1 is preferably 0 to 99.8 mass %. If the microwave burn prevention agent 1 is an emulsion, the water content is preferably 50 to 99.8 mass %, more preferably 84 to 99.5 mass %, and even more preferably 85 to 99.5 mass %. For emulsions with viscosity of 100 to 13500 mPa·s (25° C.), the moisture content is preferably 50 to 99.8 mass %, more preferably 84 to 99.5 mass %, and even more preferably 85 to 99.5 mass %.

### <Other Ingredients>

In addition to the above ingredients, the microwave burn prevention agent 1 in the present embodiment can use raw materials commonly blended in microwave burn prevention agents. Specifically, for example, ethanol, pH adjusters, seasonings, coloring agents, flavorings, antioxidants, sugars, polyhydric alcohols, stabilizers, emulsifiers, etc. can be used. Polyhydric alcohols include glycerin, sorbitol, and reduced syrup, but not polysaccharide thickeners. The amount of these ingredients can be any amount as long as the effect of this embodiment is not impaired. For example, the microwave burn prevention agent 1 can contain these ingredients of 10 mass % or less, preferably 3 mass % or less, more preferably 0 to 3 mass %, and even more preferably 0 to 1 mass %. Since polyhydric alcohols and ethanol change the physical properties of the aqueous solution, it is preferable to have less content of these ingredients in the emulsion when the amount of water in the emulsion is low. For example, when the amount of water in the emulsion is 83 mass % or less, the content of polyhydric alcohol and ethanol is less than 3 mass %, more preferably 0 to 2 mass %, even more preferably 0 to 1 mass %, and most preferably none.

### <Foods>

The microwave burn prevention agent 1 in the present embodiment is used for foods (i.e., food products), which include frozen foods and chilled/refrigerated foods. Frozen food can be defrosted and/or heated in a microwave oven, and chilled/refrigerated food can be heated in a microwave oven and eaten.

These foods include starch-containing foods, vegetables, fish, crustaceans, and meat. Starch-containing foods include noodles such as soba, udon, Chinese noodles, and pasta, as well as rice products such as cooked rice, fried rice, curry rice, rice bowls, and processed noodle skin products such as dumplings.

The microwave burn prevention agent 1 in the present embodiment can be applied to the surface of these foods as an emulsion having a viscosity of 50 to 13500 mPa·s (25° C.). The amount of microwave burn prevention agent 1 applied to the surface of foods is preferably 0.1 to 7 mass parts as an emulsion per 100 mass parts of food, and it is more preferable to apply the emulsion to the surface of foods so that the amount of microwave burn prevention agent 1 is 0.2 to 5.0 mass parts.

### [Method for Preventing Microwave Burn of Food]

The method for preventing microwave burn of food in the present embodiment is to apply the aforementioned microwave burn prevention agent 1 to the surface of foods. That is, the method for preventing microwave burn of food in the present embodiment is a method for preventing microwave burn of food by microwave heating is to apply an emulsion having a viscosity of 100 to 13500 mPa·s (25° C.) to the surface of food before heating in a microwave oven, wherein said emulsion is the microwave burn prevention agent 1 mentioned above, or an emulsion of the microwave burn prevention agent 1 with added water, and the total amount of oil and/or fat, emulsifier, and polysaccharide thickener in the emulsion is 0.08 to 3 mass parts per 100 mass parts of the food.

In the method for preventing microwave burn of food in the present embodiment, the emulsion may be made to have a viscosity of more than 100 mPa·s (25° C.) by emulsification and then reduced to a viscosity of 100 to 13500 mPa·s (25° C.) by adding water with mixing, to apply the emulsion to the food.

A certain amount of the emulsion, especially the components other than water in the emulsion, is required to produce the microwave burn prevention effect in the present embodiment. Therefore, the total amount of fat, oil, emulsifier, and polysaccharide thickener in the emulsion should be applied to the food surface so that the total amount of fat/oil, emulsifier, and polysaccharide thickener in the emulsion is 0.08 to 3 mass parts per 100 mass parts of food. The total amount of oil and/or fat, emulsifier, and polysaccharide thickener in the emulsion is preferably 0.3 to 3 mass parts, more preferably 0.45 to 2.5 mass parts, even more preferably 0.5 to 1.5 mass parts, and most preferably 0.7 to 1.2 mass parts, per 100 mass parts of the food.

Details of the microwave burn prevention agent 1 used in this method for preventing microwave burn of food in the present embodiment and the resulting food are as described above in [Microwave burn prevention agent 1]. The method for applying the microwave burn prevention agent 1 to the surface of the food is not particularly limited but may include dipping, spraying, dressing, and the like. The application to the food surface may be performed before, during, or after cooking the food and may be performed multiple times. If the food is a frozen food, the application to the food surface may be performed before, during, or after freezing and may be performed multiple times, but preferably before freezing.

### [Production Method for Frozen Food]

In the production method for frozen food in the present embodiment, the aforementioned method of preventing microwave burn of food is used for producing a frozen food. That is, the production method for frozen food in the present embodiment is a production method for frozen food to be heated in a microwave oven and eaten, and includes a step of applying an emulsion having a viscosity of 100 to 13500 mPa·s (25° C.) to the surface of food before heating in a microwave oven, and then freezing the food, wherein said emulsion is the aforementioned microwave burn prevention agent 1, or an emulsion of the microwave burn prevention agent 1 with added water, wherein the total amount of oil and/or fat, emulsifier, and polysaccharide thickener in the emulsion is 0.08 to 3 mass parts per 100 mass parts of the food. Details are as described above in [Microwave burn prevention agent 1] and [Method for preventing microwave burn of food].

### Second Embodiment

### [Microwave Burn Prevention Agent 2]

Microwave burn prevention agent 2 in the present embodiment is a microwave burn prevention agent for preventing microwave burn of starch-containing foods caused by microwave heating, said microwave burn prevention agent 2 is applied to starch-containing food between a heating and cooking step and a freezing or refrigeration step of the starch-containing food, and the microwave burn prevention agent 2 contains 70 to 99.9 mass % of oil and/or fat, and 0.1 to 30 mass % of an emulsifier, wherein the emulsifier is selected from one or more of propylene glycol fatty acid esters, polyglycerol fatty acid esters having HLB of 2 to 8, polyglycerol condensed-ricinoleate esters, organic acid monoglycerides, sucrose fatty acid esters having HLB of 1 to 3, and sorbitol fatty acid esters having HLB of 2 to 8.

### <Starch-Containing Food>

The microwave burn prevention agent 2 in the present embodiment is applied to a starch-containing food that has undergone a heating and cooking step, followed by a freezing or refrigeration step to make a frozen starch-containing food, and the microwave burn prevention effect is obtained by applying it before the freezing step. When using this type of microwave burn prevention agent 2 in the heating and cooking step, it should be applied after the heating and cooking step because it is absorbed into the starch-containing food and is not expected to be effective enough.

The heating and cooking step include boiling, steaming, frying, deep-frying, etc. In order for the microwave burn prevention agent 2 to be fully effective, a sufficient concentration of the microwave burn prevention agent 2 must be present on the surface of the starch-containing food. The amount of oil and/or fat contained in the starch-containing food that has undergone the heating and cooking step is not a problem but less oil and/or fat on the surface of the food is preferred. For example, the amount of oil and/or fat on the surface of the starch-containing food that has undergone the heating and cooking step is preferably less than 1 mass %, more preferably 0.5 mass % or less, and even more preferably 0.2 mass % or less, of the starch-containing food. It is also preferable that the food is cooked by boiling or steaming.

The amount of oil and/or fat on the surface of the food can be confirmed by lightly wiping the surface of the food with a cotton ball containing hexane, etc., and measuring the amount of oil that has migrated to the cotton ball.

Starch-containing foods include noodles such as soba, udon, Chinese noodles, and pasta, as well as rice products such as cooked rice, fried rice, curry rice, rice bowls, and processed noodle skin products such as dumplings.

<Oil and/or Fat>

The microwave burn prevention agent 2 contains 70 to 99.9 mass % of oil and/or fat. As oil and/or fat, animal and vegetable fats, oil and/or fat synthesized from glycerin and fatty acids, and their fractionated oils, esterified oils, hydrogenated oils, etc. can be used alone or in combination. The type of each fat/oil is the same as in the first embodiment.

When 70 to 99.9 mass % of oil and/or fat is contained in the microwave burn prevention agent 2 in the present embodiment, together with the emulsifier described below, the microwave burn prevention property is within an acceptable range. The microwave burn prevention agent 2 in the present embodiment preferably contains 90 to 99.5 mass % oil and/or fat in the microwave burn prevention agent 2. The amount of oil and/or fat in the microwave burn prevention agent 2 is more preferably 95 to 99.5 mass %, even more preferably 97 to 99.5 mass %, and especially preferably 98 to 99.5 mass %.

### <Emulsifier>

The microwave burn prevention agent 2 in the present embodiment contains 0.1 mass % or more of a specific emulsifier to prevent microwave burn. Therefore, the microwave burn prevention agent 2 in the present embodiment contains 0.1 to 30 mass % of one or more emulsifiers selected from propylene glycol fatty acid esters, polyglycerol fatty acid esters having HLB of 2 to 8, polyglycerol condensed-ricinoleate esters, sucrose fatty acid esters having HLB of 1 to 3, and sorbitan fatty acid esters having HLB of 2 to 6.

In the emulsifier selected from propylene glycol fatty acid esters, polyglycerol fatty acid esters having HLB of 2 to 8, sucrose fatty acid esters having HLB of 1 to 3, and sorbitan fatty acid esters having HLB of 2 to 6 used in the microwave burn prevention agent 2 in the present embodiment, it is preferred that 60% or more of the constituent fatty acids are unsaturated fatty acids to prevent solidification at low temperature. It is more preferred that 70 to 100 mass % of the constituent fatty acids are unsaturated fatty acids, and it is even more preferred that 80 to 98 mass % of the constituent fatty acids are unsaturated fatty acids. The unsaturated fatty acids can be linear unsaturated fatty acids having carbon numbers of 16 to 22. As unsaturated fatty acids, one or more unsaturated fatty acids selected from oleic acid, linoleic acid, linolenic acid, and erucic acid are preferred. Particularly preferred is that 65 to 90 mass % of the constituent fatty acids are oleic acids. Fatty acids other than unsaturated fatty acids in the emulsifier are saturated fatty acids. As saturated fatty acids, linear saturated fatty acids having carbon numbers of 6 to 22 are preferred, linear saturated fatty acids having carbon numbers of 16 to 22 are more preferred, and one or more of palmitic acid, stearic acid, and behenic acid are even more preferred.

The microwave burn prevention agent 2 in the present embodiment preferably contains 0.5 to 10 mass %, more preferably 0.5 to 5 mass %, even more preferably 0.5 to 3 mass %, and especially preferably 0.5 to 3 mass % of one or more emulsifiers selected from propylene glycol fatty acid esters, polyglycerol fatty acid esters having HLB of 2 to 8, polyglycerol condensed-ricinoleate esters, sucrose fatty acid esters having HLB of 1 to 3, and sorbitan fatty acid esters having HLB of 2 to 6, in the microwave burn prevention agent.

The microwave burn prevention agent 2 in the present embodiment preferably contains 0.1 to 30 mass %, more preferably 0.5 to 10 mass %, even more preferably 0.5 to 5 mass %, especially preferably 0.5 to 3 mass %, and most preferably 0.5 to 3 mass % of one or more emulsifiers selected from propylene glycol fatty acid esters, and polyglycerol fatty acid esters having HLB of 2 to 8, in the microwave burn prevention agent 2.

The microwave burn prevention agent 2 in the present embodiment preferably contains 0.5 to 10 mass %, more preferably 0.5 to 5 mass %, even more preferably 0.5 to 3 mass %, and especially preferably 0.5 to 3 mass % of one or more emulsifiers selected from polyglycerol condensed-ricinoleate esters, sucrose fatty acid esters having HLB of 1 to 3, and sorbitan fatty acid esters having HLB of 2 to 6, in the microwave burn prevention agent 2.

Propylene glycol fatty acid esters are esters of propylene glycol and fatty acids. Commercially available products may be used, or products made by conventionally known methods may be used. Commercially available products include Type BP (HLB 4.2), Rikemar PP-100 (HLB 3.8), Rikemar PO-100V (HLB 3.6) manufactured by Riken Vitamin Co., Ltd., etc., and can be used as appropriate. Propylene glycol fatty acid esters having HLB of 3 to 10 can be suitably used, and those having HLB of 3 to 5 are more preferred.

Polyglycerol fatty acid esters having HLB of 2 to 8 are esters of polyglycerol and fatty acids. Commercially available products may be used, or products made by conventionally known methods may be used. Commercially available products include Sunsoft Q-17B (HLB 6.5), Sunsoft Q-175S (HLB 4.5), Sunsoft Q1710S (HLB 3.0), Sunsoft A-173E (HLB 7.0) manufactured by Taiyo Kagaku Co., Ltd., Poem DO-100V (HLB 7.3) manufactured by Riken Vitamin Co., Ltd., and can be used as appropriate.

HLB of polyglycerol fatty acid esters is preferably 3 to 10, and HLB of emulsifiers is preferably 3 to 8, and more preferably 6 to 8.

Polyglycerin used as a raw material for polyglycerol fatty acid esters is generally obtained by dehydration-condensation of glycerin at high temperature in the presence of an alkali catalyst such as caustic soda, followed by distillation, deodorization, and decolorization as necessary. Polyglycerol, the raw material for these polyglycerol fatty acid esters, is also called reactive polyglycerol, and is a mixture of polyglycerol of different degrees of polymerization and has a wide degree of polymerization distribution. Polyglycerol fatty acid esters are generally allowed to be mixtures of polyglycerol fatty acid esters of various degrees of polymerization, since those with a degree of polymerization of 4 or more are difficult to isolate. Polyglycerol in the polyglycerol fatty acid esters of the present invention can have an average degree of polymerization from 2 to 40. The average degree of polymerization of the polyglycerol portion of the polyglycerol fatty acid esters is more preferably 2 to 12, and even more preferably 2 to 4.

Polyglycerol condensed-ricinoleate esters may be commercially available or produced by known conventional methods. Commercial products include, for example, SY-Glyster CR-310, SY-Glyster CR-500, SY-Glyster CR-ED, and SY-Glyster CRS-75 manufactured by Sakamoto Yakhin Kogyo Co., Ltd., Sunsoft No. 818DG, Sunsoft 818R, Sunsoft 818SK, Sunsoft 818H, manufactured by Taiyo Kagaku Co., Ltd., and can be used as appropriate.

HLB of polyglycerol condensed-ricinoleate esters is preferably 3 or less, and more preferably 1 to 2. The average degree of polymerization of polyglycerol in polyglycerol condensed-ricinoleate esters is preferably 4 to 12, and more preferably 4 to 10.

Organic acid monoglycerides are esters of fatty acid monoglycerides and organic acids, and may be commercially available or made by conventionally known methods. Organic acids constituting organic acid monoglycerides are not particularly limited, but citric acid, succinic acid, acetic acid, tartaric acid, butyric acid, etc. can be suitably used. Citric acid is particularly preferred because of its high microwave burn prevention effect. Commercially available products such as Sunsoft No. 621B, Sunsoft No. 623M, Sunsoft No. 681NU, and Sunsoft No. 641D manufactured by Taiyo Kagaku Co., Ltd., and can be used as appropriate.

Sucrose fatty acid esters having HLB of 1 to 3 are esters of sucrose and fatty acids, and may be commercially available or manufactured by conventionally known methods. Commercial products include, for example, Ryoto Sugar Ester O-170 (HLB1), Ryoto Sugar Ester P-170 (HLB1), Ryoto Sugar Ester S-170 (H (HLB1), Ryoto Sugar Ester S-270 (HLB2), Ryoto Sugar Ester S-370 (HLB3), Ryoto Sugar Ester B-370 (HLB3), Ryoto Sugar Ester ER-290 (HLB2), Ryoto Sugar Ester POS-135 (HLB1), manufactured by Mitsubishi Chemical Corporation, and can be used as appropriate. The HLB of sucrose fatty acid esters is more preferably 1 to 2.

Sorbitan fatty acid esters having HLB of 2 to 8 are esters of sorbitan and fatty acids, and may be commercially available or manufactured by conventionally known methods. For example, Rikemar L250A (HLB 7.4), Rikemar OV-250 (HLB 4.9), Rikemar OR-85 (HLB 3.0), and Poem O-80V (HLB 4.9) manufactured by Riken Vitamin Co., Ltd, etc., and can be used as appropriate. HLB of sorbitan fatty acid esters is more preferably 3 to 6, and even more preferably 4 to 5.

The emulsifier contained in the microwave burn prevention agent 2 in the present embodiment is preferably one or more selected from propylene glycol fatty acid esters and polyglycerol fatty acid esters having HLB of 2 to 8.

### <Other Ingredients>

In addition to the above ingredients, the microwave burn prevention agent 2 in the present embodiment can use raw materials commonly blended in microwave burn prevention agents. Specifically, for example, seasonings, coloring agents, flavorings, antioxidants, stabilizers, emulsifiers other than the above emulsifiers, etc. can be used. The amount of these ingredients can be any amount as long as the effect of this embodiment is not impaired. For example, the microwave burn prevention agent 2 can contain these ingredients of 10 mass % or less, preferably 3 mass % or less, more preferably 0 to 3 mass %, and even more preferably 0 to 1 mass %. The water soluble content can also be included in the microwave burn prevention agent 2 in a solubilized state.

### <Production Method for Frozen Starch-Containing Food to be Heated by Microwave Oven>

Production method for frozen starch-containing food to be heated by microwave oven in the present embodiment is to perform a step of applying 0.5 to 10 mass parts of the aforementioned microwave burn prevention agent 2 to 100 mass parts of the starch-containing food after a heating and cooking step of the starch-containing food, followed by a freezing or refrigeration step.

In the present embodiment, frozen starch-containing foods for microwave heating include frozen foods and chilled/refrigerated foods. Frozen foods can be thawed and/or heated in a microwave oven, and chilled/refrigerated foods can be heated in a microwave oven and eaten.

Frozen starch-containing foods for microwave heating include noodles such as soba, udon, Chinese noodles, and pasta, as well as rice products such as cooked rice, fried rice, curry rice, and rice bowls, and processed noodle skin products such as dumplings.

The heating and cooking step include boiling, steaming, frying, deep-frying, etc. In order for the microwave burn prevention agent 2 to be fully effective, a sufficient concentration of the microwave burn prevention agent 2 must be present on the surface of the starch-containing food. The amount of oil and/or fat contained in the starch-containing food that has undergone the heating and cooking step is not a problem but less oil and/or fat on the surface of the food is preferred. For example, the amount of oil and/or fat on the surface of the starch-containing food that has undergone the heating and cooking step is preferably less than 1 mass %, more preferably 0.5 mass % or less, and even more preferably 0.2 mass % or less, of the starch-containing food. It is also preferable that the food is cooked by boiling or steaming.

The step of applying the microwave burn prevention agent 2 to the starch-containing food can be done, for example, by spraying the starch-containing food with the microwave burn prevention agent 2, immersing the starch-containing food in the microwave burn prevention agent 2, or mixing the starch-containing food and the microwave burn prevention agent 2. Through this step, the surface of the starch-containing food is coated with Microwave burn Prevention agent 2, and the microwave burn prevention effect of the present embodiment can be achieved. The amount of the microwave burn prevention agent 2 applied to the starch-containing food is preferably 0.5 to 7 mass parts, and more preferably 0.8 to 3.0 mass parts per 100 mass parts of the starch-containing food product.

The microwave burn prevention agent 2 is as described above in [Microwave burn prevention agent 2]. The emulsifiers contained in the microwave burn prevention agent 2 are preferably one or more of propylene glycol fatty acid esters and polyglycerol fatty acid esters having HLB of 2 to 8.

Conventional known methods can be used for the freezing step or the refrigeration step. The freezing step is to cool the starch-containing food to 0° C. or lower, and freezing at −10° C. or lower is more preferable, and freezing at −15° C. or lower is even more preferable. The refrigeration step is to cool the starch-containing food to 0 to 10° C., and cooling to 0 to 5° C. is more preferable. In order to fix the microwave burn prevention agent 2 on the surface of the starch-containing food, the freezing step is preferred, and quick freezing at −10° C. or lower is even more preferred.

### Example 1

Next, examples and comparative examples are given for each of the first and second embodiments to further explain the invention in detail, but the invention is not limited in any way to these examples. In the following, “%” indicates mass % unless otherwise stated.

### [Microwave Burn Prevention Agent 1: Reference Example 1-1, Comparative Examples 1-2 to 1-5]

Microwave burn prevention agent 1 was prepared according to the formulations in Tables 1 to 3. The oil and/or fat, emulsifiers, and polysaccharide thickeners used were as follows.
MCT (Medium Chain Triglycerides: manufactured by The Nisshin OilliO Group, Ltd.: Constituting fatty acids are 60% caprylic acid and 40% capric acid)
Rapeseed oil (Refined canola oil, trade name “Nissin Canola Oil” manufactured by The Nisshin OilliO Group, Ltd.)
Diglycerin monooleate esters (Trade name “Poem DO-100V” manufactured by Riken Vitamin Co., Ltd.: HLB 7.3)
Decaglycerin pentaoleate esters (Trade name “Sunsoft Q-175S” manufactured by Taiyo Kagaku Co., Ltd.: HLB 7)
Xanthan gum (Trade name “Neosoft XR” manufactured by Taiyo Kagaku Co., Ltd.) Guar gum (Trade name “VIDOGUM GHK175” manufactured by Unitec Foods Co., Ltd.)

For Reference Example 1-1, water was used as the sample.

Comparative Examples 1-1 to 1-3 were samples mixed with the formulations in Table 1.

In Comparative Example 1-4, the oil-based component of oil and/or fat and emulsifiers were mixed according to the formulation in Table 1. The sample was obtained by further mixing the oil-based component with water to form an emulsion.

In Comparative Example 1-5 and Examples 1-1 to 1-15, the oil-based component of oil and/or fat and emulsifiers were mixed according to the formulations of Tables 1 to 3. In addition, the sample was obtained by dispersing the polysaccharide thickener in the oil-based component, and mixing the oil-based component with water to form an emulsion.

### [Viscosity]

The viscosity of each sample at 25° C. was measured with a Brookfield viscometer (BM viscometer, trade name “VISCOMETER TVB-15” manufactured by Toki Sangyo Co., Ltd.) 1 minute after the start of rotation.

### [Microwave Burn Performance]

### (Microwave Heating of Udon Noodles)

Commercially available frozen udon noodles (manufactured by TableMark Co., Ltd.) were thawed in boiling water for 1 minute, cooled in cold water, and drained. Samples were added to the resulting udon noodles in the blending amounts shown in Tables 1 to 3, mixed, and applied to the surface of the udon noodles. The applied amount (mass parts) of samples and the total amount of oil and/or fat, emulsifier, and polysaccharide thickener (mass parts) per 100 mass parts of food are shown in Tables 1 to 3.

60 g of udon noodles coated with the microwave burn prevention agent 1 were placed in a container, quick-frozen (−30° C.), and after frozen, stored in a −18° C. freezer for 12 hours to make frozen udon noodles. 60 g of frozen udon noodles were microwaved and overheated (600 W, 2 minutes) to facilitate microwave burn. Thus, heated udon noodles were obtained.

### (Breaking Strength)

The breaking strength (i.e., rupture strength) of heated udon noodles was measured to evaluate microwave burn. The breaking strength was measured using a Texture Analyzer (Model number “TA.XA Plus” manufactured by Stable Micro Systems Ltd.) (Measurement conditions: Descent speed 1 mm/sec, Blade Set as jig, Strain set to stop at 98%). The obtained breaking strength (Maximum strength measured when ruptured to 98%) is shown in Tables 1 to 3.

The higher the breaking strength value, the more microwave burned and harder the udon noodles are.
Breaking strength of 2001 g or more: x (Failure)
Breaking strength of 1601 to 2000 g: ● (Acceptable)
Breaking strength of 1201 to 1600 g: ∘ (Acceptable: Good)
Breaking strength of 1200 or less: ⊚ (Acceptable: Excellent)

TABLE 1

| Reference | Comparative | Comparative | Comparative | Comparative | Comparative | |
|---|---|---|---|---|---|---|
| Example | Example | Example | Example | Example | Example | Example |
| 1-1 | 1-1 | 1-2 | 1-3 | 1-4 | 1-5 | 1-1 |

| | | | | | | | |
|---|---|---|---|---|---|---|---|
| Fat and/or oil | MCT | | | 5.0 | 5.0 | 5.0 | 5.0 |
| | [mass %] | | | | | | |
| | Rapeseed oil | 5.0 | | | | | |
| | [mass %] | | | | | | |
| Emulsifiers | Diglycerin | | | | 1.0 | 4.0 | 4.0 |
| | monooleate | | | | | | |
| | esters | | | | | | |
| | [mass %] | | | | | | |
| | Decaglycerol | | | | | | |
| | pentaoleate | | | | | | |
| | esters | | | | | | |
| | [mass %] | | | | | | |
| Polysaccharide | Xanthan gum | | 0.3 | 03 | | 0.5 | 0.5 |
| thickeners | [mass %] | | | | | | |
| | Guar gum | | | | | | |
| | [mass %] | | | | | | |

| | | | | | | |
|---|---|---|---|---|---|---|
| Water | 95.0 | 99.7 | 94.7 | 94.0 | 90.5 | 90.5 |
| [mass %] | | | | | | |
| Applied amount per 100 mass | 5 | 5 | 5 | 5 | 0.5 | 1 |
| parts of food | | | | | | |
| [mass parts] | | | | | | |
| Total amount of fat/oil, emulsifier, | 0.25 | 0.015 | 0.27 | 0.30 | 0.048 | 0.095 |
| and polysaccharide thickener | | | | | | |
| [mass parts per 100 mass parts of | | | | | | |
| food] | | | | | | |
| Viscosity | 2.5 | 231.1 | 211.2 | 26.7 | 1561 | 1561 |
| [m · Pas] | (M1, 60) | (M1, 30) | (M1, 30) | (M1, 30) | (M2, 12) | (M2, 12) |
| (Rotor No., rpm) | | | | | | |
| Breaking strength | 2041.3 | 2025.1 | 2101.5 | 2051.1 | 2021.5 | 1899.4 |
| [g] | X | X | X | X | X | ● |

TABLE 2

| | | Example | Example | Example | Example | Example | Example | Example |
|---|---|---|---|---|---|---|---|---|
| | | 1-2 | 1-3 | 1-4 | 1-5 | 1-6 | 1-7 | 1-8 |
| Fat and/or oil | MCT | 5.0 | 5.0 | 5.0 | 5.0 | 5.0 | | 5.0 |
| | [mass %] | | | | | | | |
| | Rapeseed oil | | | | | | 5.0 | |
| | [mass %] | | | | | | | |
| Emulsifiers | Diglycerin | 4.0 | 4.0 | 4.0 | 4.0 | 4.0 | 4.0 | |
| | monooleate | | | | | | | |
| | esters | | | | | | | |
| | [mass %] | | | | | | | |
| | Decaglycerol | | | | | | | 4.0 |
| | pentaoleate | | | | | | | |
| | esters | | | | | | | |
| | [mass %] | | | | | | | |
| Polysaccharide | Xanthan gum | 0.5 | 0.5 | 0.5 | 0.5 | 0.5 | 0.5 | 0.5 |
| thickeners | [mass %] | | | | | | | |
| | Guar gum | | | | | | | |
| | [mass %] | | | | | | | |

| | | | | | | | |
|---|---|---|---|---|---|---|---|
| Water | 90.5 | 90.5 | 90.5 | 90.5 | 90.5 | 90.5 | 90.5 |
| [mass %] | | | | | | | |
| Applied amount per 100 mass | 2 | 5 | 10 | 20 | 30 | 5 | 5 |
| parts of food | | | | | | | |
| [mass parts] | | | | | | | |
| Total amount of fat/oil, emulsifier, | 0.19 | 0.48 | 0.95 | 1.9 | 2.85 | 0.48 | 0.48 |
| and polysaccharide thickener | | | | | | | |
| [mass parts per 100 mass parts of | | | | | | | |
| food] | | | | | | | |
| Viscosity | 1561 | 1561 | 1561 | 1561 | 1561 | 1487 | 1312 |
| [m · Pas] | (M2, 12) | (M2, 12) | (M2, 12) | (M2, 12) | (M2, 12) | (M2, 12) | (M2, 12) |
| (Rotor No., rpm) | | | | | | | |
| Breaking strength | 1602.4 | 1402.3 | 1142.1 | 1235.2 | 1321.1 | 1687.5 | 1740.5 |
| [g] | ● | ◯ | ⊚ | ◯ | ◯ | ● | ● |

TABLE 3

| | | Example | Example | Example | Example | Example | Example | Example |
|---|---|---|---|---|---|---|---|---|
| | | 1-9 | 1-10 | 1-11 | 1-12 | 1-13 | 1-14 | 1-15 |
| Fat and/or oil | MCT | 5.00 | 5.00 | 5.00 | 5.00 | 5.00 | 5.00 | 5.0 |
| | [mass %] | | | | | | | |
| | Rapeseed oil | | | | | | | |
| | [mass %] | | | | | | | |
| Emulsifiers | Diglycerin | 4.00 | 4.00 | 4.00 | 4.00 | 4.00 | 4.00 | 4.0 |
| | monooleate | | | | | | | |
| | esters | | | | | | | |
| | [mass %] | | | | | | | |
| | Decaglycerol | | | | | | | |
| | pentaoleate | | | | | | | |
| | esters | | | | | | | |
| | [mass %] | | | | | | | |
| Polysaccharide | Xanthan gum | 0.05 | 0.10 | 0.20 | 1.00 | 2.00 | 2.50 | |
| thickeners | [mass %] | | | | | | | |
| | Guar gum | | | | | | | 0.3 |
| | [mass %] | | | | | | | |

| | | | | | | | |
|---|---|---|---|---|---|---|---|
| Water | 90.95 | 90.90 | 90.80 | 90.00 | 89.00 | 88.50 | 90.7 |
| [mass %] | | | | | | | |
| Applied amount per 100 mass | 5 | 5 | 5 | 5 | 5 | 5 | 5 |
| parts of food | | | | | | | |
| [mass parts] | | | | | | | |
| Total amount of fat/oil, emulsifier, | 0.45 | 0.46 | 0.46 | 0.50 | 0.55 | 0.58 | 0.47 |
| and polysaccharide thickener | | | | | | | |
| [mass parts per 100 mass parts of | | | | | | | |
| food] | | | | | | | |
| Viscosity | 104 | 280 | 560 | 3450 | 8500 | 13200 | 795 |
| [m · Pas] | (M2, 12) | (M2, 12) | (M2, 12) | (M2, 12) | (M4, 12) | (M4, 12) | (M2, 12) |
| (Rotor No., rpm) | | | | | | | |
| Breaking strength | 1847.1 | 1777.2 | 1552.1 | 1501.1 | 1441.5 | 1474.2 | 1889.5 |
| [g] | ● | ● | ◯ | ◯ | ◯ | ◯ | ● |

Examples 1-1 to 1-15 all had lower breaking strength than Reference Example 1-1 and Comparative Examples 1-1 to 1-5 and were effective in preventing microwave burn.

### [Microwave Burn Prevention Agent 2]

Microwave burn prevention agent 2 was prepared according to the formulations in Tables 4 to 6. In Comparative Example 2-3 and Examples 2-1 to 2-15, the emulsifier and oil and/or fat were heat-mixed (40 to 60° C.) to make Microwave burn Prevention agent 2. The fat/oil, and emulsifiers used were as follows.

(Oil and/or Fat)
Rapeseed oil (Refined canola oil, trade name “Nissin Canola Oil” manufactured by The Nisshin OilliO Group, Ltd.)

### (Emulsifiers)

PE (Propylene glycol oleate esters, trade name “Rikemar PO-100V” manufactured by Riken Vitamin Co., Ltd.: HLB 3.6)
PGE1 (Decaglycerol decaoleate esters, trade name “Sunsoft Q-1710S” manufactured by Taiyo Kagaku Co., Ltd.: HLB 3)
PGE2 (Diglycerin monooleate esters, trade name “Poem DO-100V” manufactured by Riken Vitamin Co., Ltd.: HLB 7.3)
PGPR1 (Pentaglycerol condensed-ricinoleate esters, trade name “Sunsoft No. 818R” manufactured by Taiyo Kagaku Co., Ltd.)
PGPR2 (Hexaglycerol condensed-ricinoleate esters, trade name “SY-Glyster CR-500” manufactured by Sakamoto Yakhin Kogyo Co., Ltd.)
Organic acid MG (Glycerol citrate monooleate, trade name “Sunsoft No. 623M” manufactured by Taiyo Kagaku Co., Ltd.: HLB 7)
SOE (Sorbitan oleate esters, trade name “Poem O-80V” manufactured by Riken Vitamin Co., Ltd.: HLB 4.9)
SUE1 (Sucrose stearate esters, trade name “Ryoto Sugar Ester S-170” manufactured by Mitsubishi Chemical Corporation: HLB 1)
SUE2 (Sucrose oleate esters, trade name “Ryoto Sugar Ester O-170” manufactured by Mitsubishi Chemical Corporation: HLB 1)
SUE3 (Sucrose palmitate esters, trade name “Ryoto Sugar Ester P-170” manufactured by Mitsubishi Chemical Corporation: HLB 1)
SUE4 (Sucrose palmitate esters, trade name “Ryoto Sugar Ester S-1670” manufactured by Mitsubishi Chemical Corporation: HLB 16)

### [Microwave Burn Performance]

### (Microwave Heating of Noodles)

Commercially available pasta (dried noodles manufactured by Nisshin Seifun Welna Inc.) was boiled in boiling water for 7 minutes, cooled in cold water, and drained. To the resulting pasta, 2 mass parts of the microwave burn prevention agent 2, which was formulated according to the blending amounts in Tables 4 to 6, per 100 mass parts of pasta were added and mixed (applied to the pasta surface). Reference Example 2-1 is an example of production without microwave burn prevention agent 2.

60 g of pasta coated with the microwave burn prevention agent 2 was placed in a container, flash-frozen (−30° C.), frozen, and stored in a −18° C. freezer for 12 hours to make frozen pasta. 60 g of frozen pasta was microwaved in excess (600 W, 2 min) to facilitate microwave burn, and thawed pasta was obtained.

### (Breaking Strength)

The breaking strength of the heated pasta was measured to evaluate microwave burn. The breaking strength was measured using a Texture Analyzer (Model number “TA.XA Plus” manufactured by Stable Micro Systems Ltd.) (Measurement conditions: Descent speed 1 mm/sec, Blade Set as jig, Strain set to stop at 98%). The obtained breaking strength (maximum strength measured when ruptured to 98%) is shown in Tables 4 to 6. The higher the breaking strength value, the more microwave burned and harder the pasta are.
Breaking strength of 2801 g or more: x (Failure)
Breaking strength of 2601 to 2800 g: ● (Acceptable)
Breaking strength of 2101 to 2600 g: ∘ (Acceptable: Good)
Breaking strength of 2100 or less: ⊚ (Acceptable: Excellent)

TABLE 4

| | Reference | Comparative | | | | | |
|---|---|---|---|---|---|---|---|
| | Example | Example | Example | Example | Example | Example | Example |
| | 2-1 | 2-1 | 2-1 | 2-2 | 2-3 | 2-4 | 2-5 |
| Rapeseed oil | — | 100 | 99 | 99 | 99 | 99 | 99 |
| [mass %] | | | | | | | |
| PE | — | — | 1 | — | — | — | — |
| PGE1 | — | — | — | 1 | — | — | — |
| [mass %] | | | | | | | |
| PGE2 | — | — | — | — | 1 | — | — |
| [mass %] | | | | | | | |
| PGPR1 | — | — | — | — | — | 1 | — |
| [mass %] | | | | | | | |
| PGPR2 | — | — | — | — | — | — | 1 |
| [mass %] | | | | | | | |
| Breaking | 3139.2 | 2845.1 | 1852.7 | 2511.7 | 2016.5 | 2701.1 | 2644.3 |
| strength | X | X | ⊚ | ◯ | ⊚ | ● | ◯ |
| [g] | | | | | | | |

TABLE 5

| | | | | | | Comparative |
|---|---|---|---|---|---|---|
| | Example | Example | Example | Example | Example | Example |
| | 2-6 | 2-7 | 2-8 | 2-9 | 2-10 | 2-2 |
| Rapeseed oil | 99 | 99 | 99 | 99 | 99 | 99 |
| [mass %]. | | | | | | |
| Organic acid | 1 | — | — | — | — | — |
| MG | | | | | | |
| [mass %]. | | | | | | |
| SOE | — | 1 | — | — | — | — |
| [mass %] | | | | | | |
| SUE1 | — | — | 1 | — | — | — |
| [mass %] | | | | | | |
| SUE2 | — | — | — | 1 | — | — |
| [mass %] | | | | | | |
| SUE3 | — | — | — | — | 1 | — |
| [mass %] | | | | | | |
| SUE4 | — | — | — | — | — | 1 |
| [mass %]. | | | | | | |
| Breaking | 2174.1 | 2111.6 | 2722.6 | 2666.2 | 2699.7 | 3111.1 |
| strength | ◯ | ◯ | ● | ● | ● | X |
| [g] | | | | | | |

TABLE 6

| | | | | | | Comparative |
|---|---|---|---|---|---|---|
| | Example | Example | Example | Example | Example | Example |
| | 2-11 | 2-12 | 2-13 | 2-14 | 2-15 | 2-3 |
| Rapeseed oil | 99.5 | 98 | 95 | 90 | 80 | — |
| [mass %] | | | | | | |
| PGE2 | 0.5 | 2 | 5 | 10 | 20 | 100 |
| [mass %] | | | | | | |
| Breaking | 2455.1 | 2511.4 | 2741.1 | 2779.5 | 2777.8 | 3214.5 |
| strength | ◯ | ◯ | ● | ● | ● | X |
| [g] | | | | | | |

Examples 2-1 to 2-15 all had lower breaking strength and microwave burn prevention than Reference Example 2-1 and Comparative Examples 2-1 to 2-3.

1. A microwave burn prevention agent for preventing microwave burn of food caused by microwave heating, the microwave burn prevention agent, comprising:
an oil-based component containing an oil and/or a fat and an emulsifier, and a polysaccharide thickener,
wherein the microwave burn prevention agent is used as an emulsion having a viscosity of 100 to 13500 mPa·s (25° C.) or as an emulsion with a viscosity of 100 to 13500 mPa·s (25° C.) with added water.

2. The microwave burn prevention agent, according to claim 1, wherein the oil-based component contains 20 to 80 mass % of the oil and/or the fat and 10 to 80 mass % of the emulsifier,
wherein the emulsifier has an HLB of 3 to 10.

3. The microwave burn prevention agent, according to claim 1, wherein the oil and/or the fat contains 30 mass % or more of linear saturated fatty acids having carbon numbers of 8 to 10 in fatty acids constituting the oil and/or the fat,
wherein the emulsifier is one or more selected from glycerol mono fatty acid esters, polyglycerol fatty acid esters, polyglycerol condensed-ricinoleate esters, organic acid monoglycerides, sorbitan fatty acid esters, sucrose fatty acid esters, polysorbates, propylene glycol fatty acid esters, and lecithin,
wherein the polysaccharide thickener is one or more selected from xanthan gum and galactomannan.

4. The microwave burn prevention agent, according to claim 1, wherein a mass ratio of the oil-based component and the polysaccharide thickener in the microwave burn prevention agent is 300:1 to 3:1, and/or
the polysaccharide thickener in the emulsion is 0.01 to 2.5 mass %, and/or 60 mass % or more of fatty acids constituting the emulsifier are unsaturated fatty acids in the emulsifier in the oil-based component.

5. The microwave burn prevention agent, according to claim 1, wherein the food is a frozen food.

6. A method for preventing microwave burn of food by microwave heating, comprising:
applying an emulsion having a viscosity of 100 to 13500 mPa·s (25° C.) to a surface of the food before heating in a microwave oven,
wherein the emulsion is the microwave burn prevention agent of claim 1 or an emulsion comprising the microwave burn prevention agent with added water,
wherein a total amount of the oil and/or the fat, the emulsifier, and the polysaccharide thickener in the emulsion is 0.08 to 3 mass parts per 100 mass parts of the food.

7. A production method for frozen food to be heated in a microwave oven and eaten, comprising:
a step of applying an emulsion having a viscosity of 100 to 13500 mPa·s (25° C.) to a surface of the food before heating in a microwave oven; and
a step of successively freezing the food,
wherein the emulsion is the microwave burn prevention agent of claim 1 or an emulsion comprising the microwave burn prevention agent with added water,
wherein a total amount of the oil and/or the fat, the emulsifier, and the polysaccharide thickener in the emulsion is 0.08 to 3 mass parts per 100 mass parts of the food.

8. A microwave burn prevention agent for preventing microwave burn of starch-containing food caused by microwave heating,
wherein the microwave burn prevention agent is applied to a starch-containing food between a heating and cooking step and a freezing or refrigeration step of the starch-containing food, wherein the microwave burn prevention agent contains 70 to 99.9 mass % of an oil and/or a fat and 0.1 to 30 mass % of an emulsifier,
wherein the emulsifier is one or more selected from propylene glycol fatty acid esters, polyglycerol fatty acid esters having HLB of 2 to 8, polyglycerol condensed-ricinoleate esters, organic acid monoglycerides, sucrose fatty acid esters having HLB of 1 to 3, and sorbitan fatty acid esters having HLB of 2 to 8.

9. The microwave burn prevention agent, according to claim 8, wherein the emulsifier is one or more selected from propylene glycol fatty acid esters and polyglycerol fatty acid esters having HLB of 2 to 8.

10. A production method for starch-containing food to be heated in a microwave oven, comprising:
after a step of heating and cooking the starch-containing hood, conducting a step of applying 0.5 to 10 mass parts to 100 mass parts of the microwave burn prevention agent of claim 8 a starch-containing food after the cooking process of the starch-containing food, followed by a step of freezing or refrigerating the starch-containing food.

11. The production method for starch-containing food to be heated in a microwave oven, according to claim 10,
wherein the emulsifier contained in the microwave burn prevention agent is one or more selected from propylene glycol fatty acid esters and polyglycerol fatty acid esters having HLB of 2 to 8.
